(19) United States
(12) Patent Application Publication
(10) Pub. No.: US 2007/0296864 A1
(43) Pub. Date: Dec. 27, 2007

(54) Digital television receiver and method for processing broadcast signal

(76) Inventor: Kwan Suk Kim, Seoul (KR)

Correspondence Address: MCKENNA LONG & ALDRIDGE LLP;Song K. Jung, 1900 K Street, N.W., Washington, DC, 20006, US

(21) Appl. No.: 11/806,244

(22) Filed: May 30, 2007

(30) Foreign Application Priority Data
May 30, 2006 (JP) 10-2006-0049051

(51) Int. Cl. H04N 5/445

(52) U.S. Cl. 348/564

(57) ABSTRACT

A digital television (DTV) receiver and a method for processing a broadcast signal including real-time broadcast program information are disclosed. The broadcast receiver analyzes the real-time broadcast program information contained in the broadcast signal, and provides a user with the analyzed result, such that the user can correctly recognize the start- or end-time of the broadcast program, and can establish a viewing reservation function or a recording reservation function at an accurate time.

This application claims the benefit of Korean Patent Application No. 10-2006-0049051, filed on May 30, 2006, which is hereby incorporated by reference as if fully set forth herein.

### BACKGROUND OF THE INVENTION

1. Field of the Disclosure

The present disclosure relates to a digital television receiver and a method for processing a broadcast signal.

2. Discussion of the Related Art

Typically, a Program and System Information Protocol (PSIP) is an Advanced Television System Committee (ATSC) standard for terrestrial and cable digital broadcast technologies.

The PSIP transmits broadcast signals encoded by an MPEG-2 system to a broadcast receiver. A digital TV performs parsing of the encoded broadcast signals, and displays a variety of programs.

The PSIP can transmit/receive Audio/Video (A/V) data configured in the form of MPEG-2 video data and AC-3 audio format. The PSIP includes a variety of tables capable of transmitting information of channels of individual broadcast stations and each program of the channel, etc. There are a variety of tables, for example, a Master Guide Table (MGT), a Terrestrial Virtual Channel Table (TVCT), a Cable Virtual Channel Table (CVCT), a System Time Table (STT), a Rating Region Table (RRT), an Event Information Table (EIT), and an Extended Text Table (ETT), etc. Conventionally, the PSIP can provide users with a variety of information associated with each of numerous events via an Electronic Program Guide (EPG) service, etc.

However, the term “event” of the above-mentioned PSIP is indicative of a broadcast program unit. Namely, the event is a collection of associated program elements that have a common timeline for a defined period. For example, if there are broadcast programs (i.e., drama1, movie2, and news1), the broadcast programs (i.e., drama1, movie2, and news1) configure a single event.

The EPG is indicative of a program schedule including program- and summary-data of individual channels. The EPG serves as an electronic guide equal to a printed television (TV) program guide, and is generally controlled by a remote controller. Besides, the EPG may order a pay-per-view program, may search for programs for each theme or category, and may record video data, etc.

However, the above-mentioned conventional digital broadcast technology has the following disadvantages.

Firstly, the conventional digital broadcast technology unavoidably generates a considerable time difference between a time based on a broadcast program schedule provided to a user via the EPG and an actual time at which the broadcast program is actually provided to the broadcast receiver. Specifically, the above-mentioned time difference may increase due to a variety of factors, i.e., live broadcasting, advertisement advertising, or inevitable condition of a broadcast station.

Secondly, if the reserved recording is established by the conventional EPG, the broadcast receiver cannot completely record a user-desired broadcast program due to the above-mentioned time difference. For example, although the user establishes the reserved recording function of a desired broadcast program, the broadcast receiver may not record some parts of the former or latter part of the broadcast program, and may unavoidably record an unexpected part undesired by the user.

### SUMMARY OF THE INVENTION

Accordingly, the present disclosure is directed to a digital television (DTV) receiver and a method for processing the same that substantially obviate one or more problems due to limitations and disadvantages of the related art.

An object of the present disclosure is to provide a method for processing a broadcast signal associated with real-time broadcast program information, and accurately determining a start time and an end time of a specific broadcast program of a digital broadcasting, and a broadcast receiver for processing the same.

Another object of the present disclosure is to provide a method for processing a broadcast signal associated with real-time broadcast program information by allowing a user to establish a reserved recording function, such that a specific broadcast program desired by the user can be correctly recorded, and a broadcast receiver for processing the same.

Additional advantages, objects, and features of the invention will be set forth in part in the description which follows and in part will become apparent to those having ordinary skill in the art upon examination of the following or may be learned from practice of the disclosure. The objectives and other advantages of the disclosure may be realized and attained by the structure particularly pointed out in the written description and claims hereof as well as the appended drawings.

To achieve these objects and other advantages and in accordance with the purpose of the disclosure, as embodied and broadly described herein, a method of processing a digital broadcast signal in a digital television (DTV) receiver, the method comprising: receiving an event information table (EIT) containing information for a plurality of events in a predetermined time span; receiving a time stamp table (TST) associated with one of the plurality of events, the time stamp table (TST) including time stamp type information defining a status of the event and a time stamp identification (ID) identifying the time stamp table (TST); identifying the event associated with the time stamp table (TST) using the time stamp ID; and determining the status of the identified event using the time stamp type information.

In another aspect of the present disclosure, there is provided A digital television(DTV) receiver comprising: a demultiplexer for demultiplexing an event information table (EIT) containing information for a plurality of events in a predetermined time span and a time stamp table (TST) associated with one of the plurality of events, which includes time stamp type information defining a status of the event and a time stamp identification (ID) identifying the time stamp table (TST); a parser for parsing the demultiplexed information, and decoding the parsed information; and a controller for identifying the event associated with the time stamp table (TST) using the time stamp ID and determining the status of the identified event using the time stamp type information.

It is to be understood that both the foregoing general description and the following detailed description of the present invention are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this application, illustrate embodiment(s) of the invention and together with the description serve to explain the principle of the invention. In the drawings:

FIG. 1 exemplarily shows a bit stream syntax associated with a Time Stamp Table (TST);

FIG. 2 is a conceptual diagram illustrating a method for correctly determining a start time of a main broadcast program using the Time Stamp Table (TST);

FIG. 3 is a conceptual diagram illustrating a method for providing pre-notice or post-notice information associated with a start time of a main broadcast program using a Time Stamp Table (TST);

FIG. 4 exemplarily shows a bit stream syntax associated with an event information table (EIT);

FIG. 5 exemplarily shows a method for defining a time stamp descriptor of an event information table (EIT);

FIG. 6 is a conceptual diagram illustrating a method for matching a Time Stamp Table (TST) with a time stamp descriptor of FIG. 5;

FIG. 7 is a block diagram illustrating a broadcast receiver for receiving/processing a Time Stamp Table (TST) and an Event Information Table (EIT); and

FIG. 8 is a flow chart illustrating a method for receiving/processing a Time Stamp Table (TST) and an event information table (EIT).

### DETAILED DESCRIPTION OF THE INVENTION

Reference will now be made in detail to the embodiments of the present disclosure, examples of which are illustrated in the accompanying drawings. Wherever possible, the same reference numbers will be used throughout the drawings to refer to the same or like parts.

For the convenience of description and better understanding of the present disclosure, the present disclosure will sequentially describe a method for determining a start time of a main broadcast program using a Time Stamp Table (TST) syntax, a method for pre-notice/post-notice information associated with the main broadcast program start time using the Time Stamp Table (TST), a method for determining a start time of a main broadcast program using both an event information table (EIT) syntax and the Time Stamp Table (TST), a broadcast receiver for receiving/processing a Time Stamp Table (TST) and an event information table (EIT), and a method for processing a broadcast signal.

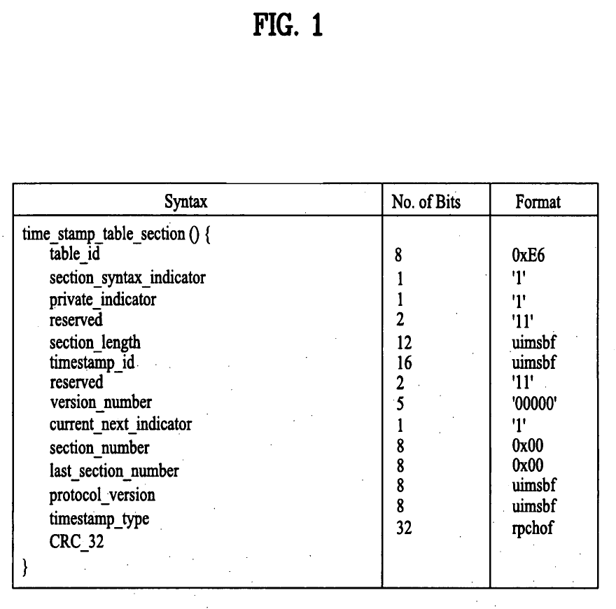

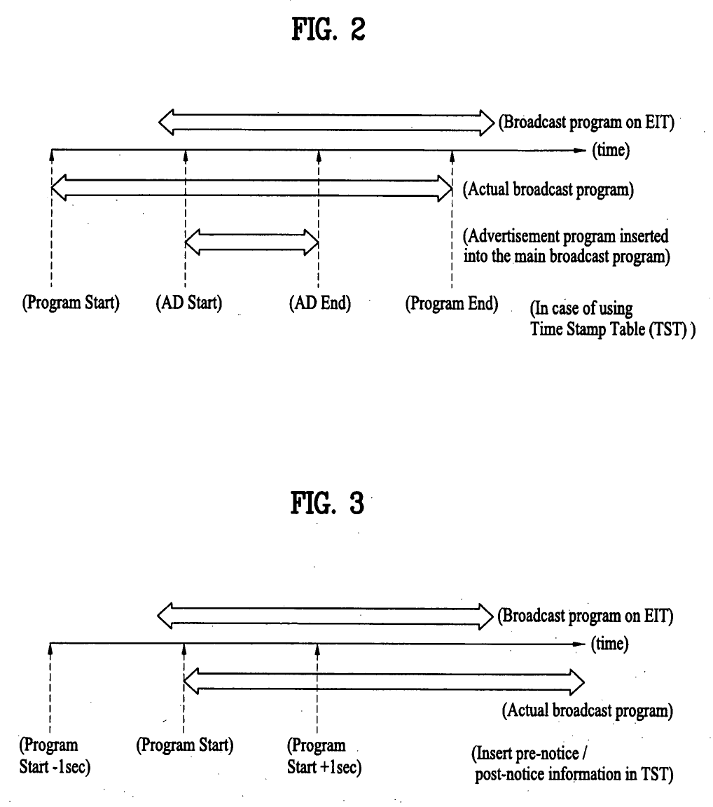

FIG. 1 exemplarily shows a bit stream syntax associated with a Time Stamp Table (TST). FIG. 2 is a conceptual diagram illustrating a method for correctly determining a start time of a main broadcast program using the Time Stamp Table (TST).

A method for determining the Time Stamp Table (TST) syntax and the start time of the main broadcast program using the TST syntax will hereinafter be described with reference to FIGS. 1 and 2.

Referring to FIG. 1, a new section data table is defined as shown in FIG. 1. The table of FIG. 1 indicates that a specific event has occurred at a reception time of a corresponding table, and this table is defined as a Time Stamp Table (TST) for the convenience of description. It should be noted that the title of the TST is disclosed for only illustrative purposes, technical characteristic data capable of being understood by those skilled in the art according to the present disclosure may be called other titles as necessary, and belongs to the scope and spirit of the inventive Time Stamp Table (TST).

The above-mentioned Time Stamp Table (TST) according to the present disclosure will hereinafter be described with reference to FIG. 1.

The “table_id” field includes specific information for identifying that this section belongs to the TST. For example, the “table_id” field has the value of “0×E6”, however, it should be noted that the value of “0×E6” is disclosed for only illustrative purposes, and can also be set to other values. In other words, the “table_id” field is an 8-bit field which shall be set to 0×E6, identifying this section as belonging to the Time Stamp Table (TST).

The “section_syntax_indicator” field may be set to the value of ‘1’. In this case, a corresponding section follows generic section syntax beyond the “section_length” field. Namely, the “section_syntax_indicator” field is a 1-bit field set to “1”, such that it denotes that the section follows the generic section syntax beyond the section length field. However, it should be noted that the value of “1” is disclosed for only illustrative purposes, and may also be set to other values as necessary.

The “private_indicator” field is a 1-bit field, and is set to the value of “1”. However, it should be noted that the value of “1” is disclosed for only illustrative purposes, and may also be set to other values as necessary.

The “section_length” field includes specific information for identifying the number of remaining bytes of section data under the “section_length” field reaching the last field of this section.

The “timestamp_id” field includes specific information for identifying whether there is a specific timestamp from among several timestamps. For example, if there are a timestamp of a “drama1” event, a timestamp of a “news2” event, and a timestamp of a “movie1” event, the “timestamp_id” field is used to distinguish the above-mentioned timestamps.

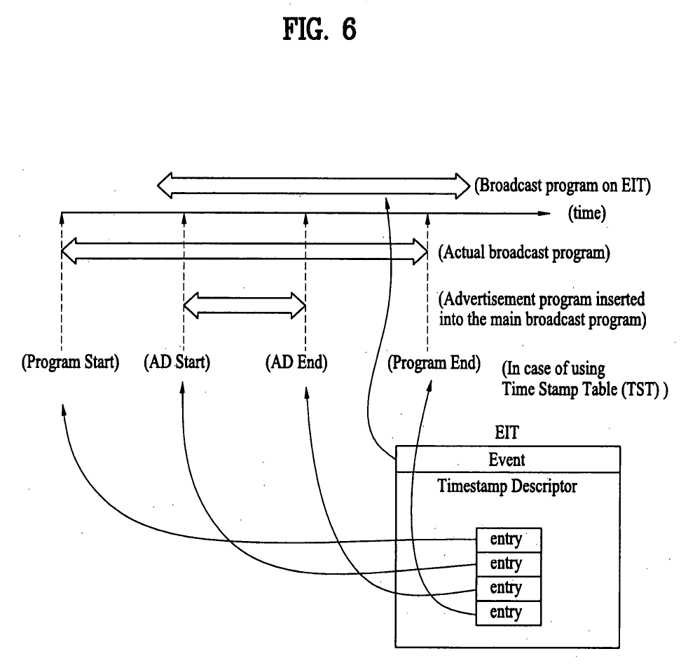

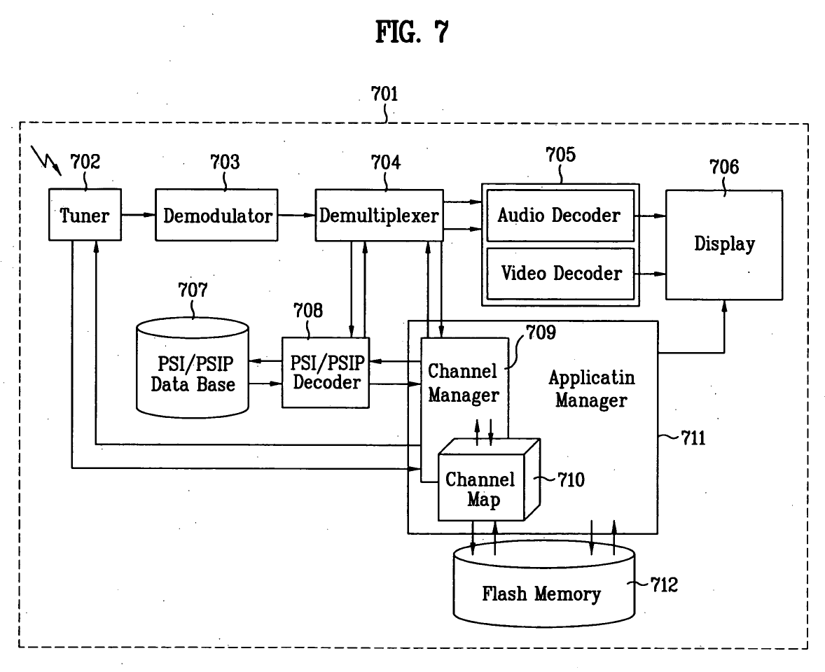

The “timestamp_id” field defines information associated with the following event information table (EIT), and a detailed description thereof will be described at a later time with reference to FIG. 6.

The “version_number” field includes information for defining a version number of the Time Stamp Table (TST). For example, if any field of the Time Stamp Table (TST) is changed, the “version_number” field may be assigned with other field values as necessary.

The “current_next_indicator” field is designed to always assign the value of “1” to the TST section. It should be noted that, the value of “1” is disclosed for only illustrative purposes, and other values may also be assigned to the “current_next_indicator” field.

The “section_number” field defines information of this section number. The “last_section_number” field includes specific information for identifying the number of the last section.

The “protocol_version” field is a field whose function is to allow, in the future, this table type to carry parameters that may be structured differently than those defined in the current protocol.

The “timestamp_type” field includes specific information for defining the type of the timestamp.

For example, if the “timestamp_type” field has the value of “0×01”, this indicates the beginning (i.e., a program start) of the main broadcast program corresponding to the specific event. If the “timestamp_type” field has the value of “0×02”, this indicates the end (i.e., a program end) of the main broadcast program corresponding to the specific event. If the “timestamp_type” field has the value of “0×11”, this indicates the beginning (i.e., an advertisement start) of the advertising in the middle of program. If the “timestamp_type” field has the value of “0×12”, this indicates the end (i.e., a program end) of the advertising in the middle of program. If the “timestamp_type” field has the value of “0×21”, this indicates an invalid start. If the “timestamp_type” field has the value of “0×22”, this indicates an invalid end. It should be noted that, the above-mentioned field values have been disclosed for only illustrative purposes, and may be set to other exemplary values as necessary.

In the meantime, whenever status of the event is changed to another during the transmission of a broadcast signal of the event, the above-mentioned Time Stamp Table (TST) is inserted into the broadcast signal packet in real time.

For the convenience of description, a detailed description thereof will hereinafter be described with reference to FIG. 2. As shown in FIG. 2, there is a considerable difference between the expected time of a broadcast program defined in the conventional EIT and the actual broadcast program time.

In the meantime, indeed, the commercials in program has been allowed under a specific broadcast system environment as in the United States

The present disclosure is characterized in that it inserts the TST having the “timestamp_type” field of “0×01” into a broadcast signal of an actual broadcast program transferred from a broadcast station. In this case, the TST includes specific information indicating the beginning of the main broadcast program.

Otherwise, the present disclosure is characterized in that it inserts the TST having the “timestamp_type” field of “0×11” into a broadcast signal, which means the beginning of advertising in the middle of program. Therefore, when the broadcast receiver receives a corresponding table, it can correctly recognize the occurrence of a specific status (e.g., the beginning or the end of either the main broadcast program or the commercials in program).

In this embodiment, a specific event generated from the broadcast station is defined, and specific information indicating a real-time status of the current specific event is defined in the Time Stamp Table (TST). Besides, instead of the TST, the above-mentioned specific information may be contained in the STT descriptor, thereby implementing the present disclosure. In addition, instead of the TST, the above-mentioned specific information may be directly contained in the A/V signals of the broadcast program, thereby implementing the present disclosure.

FIG. 3 is a conceptual diagram illustrating a method for providing pre-notice or post-notice information associated with a start time of a main broadcast program using a Time Stamp Table (TST). A method for providing pre-notice or post-notice information associated with the start time of the main broadcast program using the Time Stamp Table (TST) according to the present disclosure will hereinafter be described with reference to FIGS. 3 and 1˜2.

According to the above-mentioned embodiment, start- and end-time information of the main broadcast program and the advertisement program are notified to the broadcast receiver in real time. Compared with the above-mentioned embodiment, this embodiment of FIG. 3 is characterized in that it transmits pre-notice/post-notice information associated with start- and end-time information of the main broadcast program and the advertisement program to the broadcast receiver via the TST.

For example, if the “timestamp_type” field has the value of “0×01”, this indicates the beginning of the main broadcast program (i.e., a program start status). If the “timestamp_type” field has the value of “0×31”, this indicates the 1-second prior to the beginning (i.e., program start) of the main broadcast program. If the “timestamp_type” field has the value of “0×41”, this indicates the 1-second after the lapse of the beginning of the main broadcast program.

In this case, when the broadcast station transmits a broadcast signal of an actual broadcast program, the Time Stamp Table (TST) (e.g., “timestamp_type” field of “0×01”) indicating the beginning of the main broadcast program is inserted into the broadcast signal.

The broadcast station inserts the Time Stamp Table (TST) (e.g., “timestamp_type” field of “0×31”) into the broadcast signal at a specific time corresponding to the 1-second prior to the beginning of the main broadcast program. Otherwise, after the lapse of 1 second from the beginning of the main broadcast program, the broadcast station inserts the Time Stamp Table (TST) (e.g., “timestamp_type” field of “0×41”) which contains post-notice information indicating the above-mentioned 1-second lapse status into the broadcast signal, such that the resultant broadcast signal is transmitted.

Therefore, although the broadcast receiver does not receive the Time Stamp Table (TST) (e.g., “timestamp_type” field of “0×01”) including the start information of the main broadcast program, the broadcast receiver can check start time information of the main broadcast program using other TST as shown in FIG. 3.

Furthermore, although each of the pre-notice information and the post-notice information is transmitted once before and behind the start time of the main broadcast program as shown in FIG. 3, each of the pre-notice information and the post-notice information may also be transmitted at least two times before and behind the start time of the main broadcast program. Also, each of the pre-notice information and the post-notice information may also be transmitted before and behind other seconds other than the 1 second. Also, only the pre-notice information may be transmitted, or only the post-notice information may be transmitted. In this way, the above-mentioned content may also be applied in the case of checking end time information of the broadcast program.

In the case of transmitting the pre-notice information and the post-notice information at least two times, a transmission period of the pre-notice information may be shorter at a specific time adjacent to the start time of the main broadcast program. For example, a transmission period of the time stamp table(TST) which including the pre-notifying information becomes shorter as the start or end time is closer. And a transmission period of the time stamp table(TST) which including the post-notifying information becomes longer as the start or end time becomes more distant.

Since an amount of table data is not much although many TSTs are transmitted to a receiver, the broadcast station or broadcast receiver has no problem in processing necessary data.

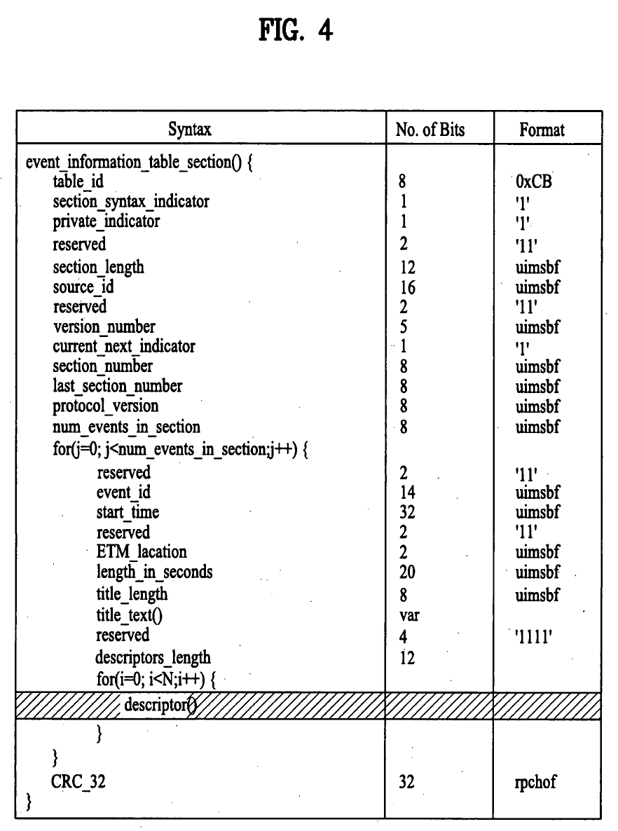

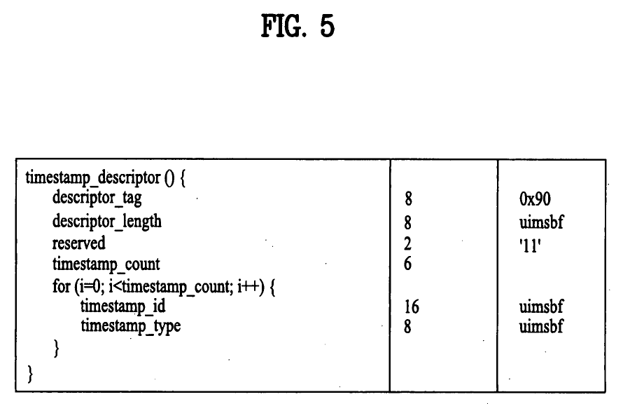

FIG. 4 exemplarily shows a bit stream syntax associated with an event information table (EIT). FIG. 5 exemplarily shows a method for defining a time stamp descriptor of an event information table (EIT). FIG. 6 is a conceptual diagram illustrating a method for matching a Time Stamp Table (TST) with a time stamp descriptor of FIG. 5.

A method for determining an event information table (EIT) syntax, and determining the start time of the event using the event information table (EIT) and the Time Stamp Table (TST) according to the present disclosure will hereinafter be described with reference to FIGS. 4˜6, and 1˜3.

The event information table (EIT) is one of tables of the PSIP including a title and a start time of at least one event of a single virtual channel. For example, if a drama1 exists, a movie2 exists, and a news1 exists, each broadcast program configures a single event.

The Event Information Table (EIT) contains information (titles, start times, etc.) for events on defined virtual channels. The EIT shall be used to provide information for virtual channels. Up to 128 EITs may be transmitted and each of them is referred to as EIT-k (where k=0, 1, . . . 127). Each EIT-k can have multiple instances, each of which contains information for one virtual channel, and each of which is identified by the combination of “table_id” and “source_id” fields.

As can be seen from FIG. 4, the EIT includes a plurality of fields. The “table_id” field is an 8-bit field which shall be set to 0×CB, identifying this section as belonging to the Event Information Table.

The “section_syntax_indicator” field includes a single bit, and is set to the value of ‘1’. In this case, a corresponding section follows generic section syntax beyond the “section_length” field. The “private_indicator” field is a 1-bit field, and is set to the value of “1”.

In association with the present disclosure, the most important part is a descriptor defined under the “for-loop” syntax, and other fields other than the descriptor will herein be omitted for the convenience of description.

The present disclosure is characterized in that the event schedule descriptor of FIG. 5 is defined in the oblique-lined descriptor of FIG. 4.

As can be seen from FIG. 5, the “descriptor_tag” field includes identification information for allowing the descriptor to identify the time stamp descriptor.

The “descriptor_tag” field may be set to the value of “0×90”, however, it should be noted that the “0×90” value is disclosed for only illustrative purposes, and other values may also be used as necessary.

The “descriptor_length” field includes specific information for defining the length from the next field to the last field of the descriptor. For example, the “descriptor_length” field may be defined in byte units.

The “timestamp_count” field includes specific information indicating the number of timestamps contained in a corresponding event identified by the “event_id” of the EIT. Each timestamp contained in the corresponding event will hereinafter be referred to as entry.

The “timestamp_id” field includes specific information for identifying a specific timestamp from among several timestamps. For example, if there are a timestamp for the “drama1” event, a timestamp for the “news2” event, and a timestamp for the “movie1” event, the above-mentioned “timestamp_id” field is required to distinguish the above-mentioned events.

Furthermore, the “timestamp_id” field of the EIT shown in FIG. 3 is designed to interwork with the “timestamp_id” field of the TST shown in FIG. 1. In conclusion, as can be seen from FIG. 6, the start- or end-information of the program of the TST corresponds to a specific entry of the timestamp descriptor of the EIT.

As described above, the EIT including the timestamp descriptor is defined, such that events in the vicinity of similar time can be distinguished from each other.

For example, if the “1-minute news broadcast program” is broadcast at 12:00 o'clock, and the “overseas movie broadcast program” is broadcast at 12:02 o'clock, the user may have difficulty in determining whether the program start information corresponds to the “1-minute news broadcast program” or the “overseas movie broadcast program”.

However, provided that the descriptor of FIG. 5 is defined, is contained in the event information table (EIT), and the resultant descriptor corresponds to the Time Stamp Table (TST), the broadcast receiver according to the present disclosure can distinguish a specific event (i.e., a broadcast program) broadcast at a similar time from others, such that it can recognize the specific event.

In the meantime, the “timestamp_type” field includes specific information indicating the start- or end-information of a specific event.

FIG. 7 is a block diagram illustrating a broadcast receiver for receiving/processing a Time Stamp Table (TST) and an Event Information Table (EIT). The broadcast receiver for receiving/processing the EIT and the TST will hereinafter be described with reference to FIGS. 7 and 1˜6.

Referring to FIG. 7, the broadcast receiver 701 includes a tuner 702, a demodulator 703, a demultiplexer 704, an A/V decoder 705, a display 706, a PSI/PSIP database 707, a PSI/PSIP decoder 708, a channel manager 709, a channel map 710, an application controller (i.e., application & UI manager) 711, and a flash memory 712, etc.

The tuner 702 may be controlled by the channel manager 709. The tuner 702 transmits the result of the received digital broadcast signal to the channel manager 709.

The demodulator 703 demodulates the signal tuned by the tuner 702 into a VSB/EVSB (Vestigial Side Band/Enhanced Vestigial Side Band). The demultiplexer 704 demultiplexes the signal demodulated by the demodulator 703 into audio data, video data, and PSI/PSIP table data. The demultiplexing of the audio and video data can be controlled by the channel manager 709. The demultiplexing of the PSI/PSIP table data can be controlled by the PSI/PSIP decoder 708.

The demultiplexer 704 transmits the demultiplexed PSI/PSIP table to the PSI/PSIP decoder 708, and the demultiplexed audio and video data is transmitted to the A/V decoder 705. The A/V decoder 705 decodes the received audio and video data. The PSI/PSIP decoder 708 performs parsing of the PSI/PSIP section, reads the remaining actual section data which has not been section-filtered by the demultiplexer 704, and records the read data in the PSI/PSIP database 707.

The channel manager 709 transmits a request for receiving a channel-associated information table by referring to the channel map 710, and receives the response to the request.

In this case, the PSI/PSIP decoder 708 controls the demultiplexing of the channel-associated information table, and transmits the A/V PID (Packet ID) list to the channel manager 709. The channel manager 709 controls the demultiplexer 504 using the transmitted A/V PID list, such that the A/V decoder 705 is controlled.

The application controller 711 controls a Graphical User Interface (GUI) for displaying status information of the broadcast receiver system on the OSD (On Screen Display).

Particularly, according to the present disclosure, the demultiplexer 704 demultiplexes the Time Stamp Table (TST) and the event information table (EIT), and transmits the demultiplexed result to the PSI/PSIP decoder 708. The Time Stamp Table (TST) and the event information table (EIT) according to the present disclosure can be readily understood by the above-mentioned preferred embodiments of FIGS. 16.

The PSI/PSIP decoder 708 detects the TST and the EIT, and determines status information of a specific event using the TST in real time. In this case, the status information of the specific event may indicate the start- or end-time of the main broadcast program, or the start- or end-time of the commercials in program.

If the user establishes a reserved recording function for a specific program using the EPG, the channel manager 709 controls the tuner 702 at a specific time indicating a real-time status determined by information acquired from the PSI/PSIP decoder 708. The application manager 709 allows only a user-desired specific broadcast program to be stored in the HDD (not shown).

If the user who has viewed the displayed screen image establishes a specific function for recording only the main broadcast program other than the commercials in program, the application manager 709 prevents the recording function from being activated at the advertising time in the middle of the program, and controls only the main broadcast program other than the commercials in program to be stored in the HDD.

Besides, the present disclosure may power on the broadcast receiver 701 when a specific broadcast program is broadcast from the broadcast station. A microprocessor (not shown) accurately determines a transmission time point of the specific broadcast program using the real-time TST information acquired from the PSI/PSIP decoder 708, such that it can power on the broadcast receiver 701 at the determined time point.

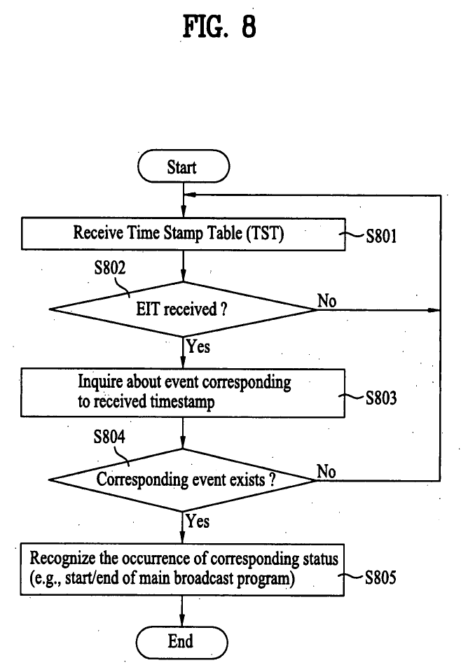

FIG. 8 is a flow chart illustrating a method for controlling the broadcast receiver capable of receiving/processing a Time Stamp Table (TST) and an event information table (EIT). A method for controlling a broadcast receiver according to the present disclosure will hereinafter be described with reference to FIGS. 8, and 1˜7.

Referring to FIG. 8, the broadcast receiver receives the Time Stamp Table (TST) at step S801. The Time Stamp Table (TST) has been fully described in the above-mentioned embodiments, such that a detailed description thereof will herein be omitted for the convenience of description.

The broadcast receiver determines whether the event information table (EIT) is received or not at step S802. Although the step S802 and the S801 are replaced with each other, it should be noted that the present disclosure can be implemented irrespective of the replacement.

If it is determined that no event information table (EIT) has been received at step S802, the broadcast receiver returns to step S801. If it is determined that the EIT has already been received at step S802, the broadcast receiver inquires about an event corresponding to the timestamp defined in the TST at step S803.

Subsequently, it is determined whether the event information table (EIT) has an event corresponding to the timestamp at step S804. If the presence of the event corresponding to the timestamp is determined at step S804, the broadcast receiver determines that the corresponding status about an event has been occurred using the “timestamp_type” field at step S805. For example, the corresponding status may indicate a start- or end-time of the main broadcast program and advertisement program.

Otherwise, if the absence of the event corresponding to the timestamp is determined at step S804, the broadcast receiver returns to step s801.

As apparent from the above description, a DTV receiver and a method for processing a broadcast signal according to the present disclosure have the following effects.

Firstly, the present disclosure can accurately determine the start- and end-time of a specific broadcast program. The present disclosure periodically provides status information of the specific broadcast program, resulting in the reduction of the possibility of generating unexpected errors.

Secondly, the present disclosure can more conveniently use additional functions of the broadcast receiver using the start- and end-time of a specific broadcast program. For example, if the user establishes a reserved recording function, the present disclosure can correctly record a user-desired specific broadcast program. Although a reserved recording function of the broadcast receiver is established, the present disclosure can allow the user to correctly view his or her desired broadcast program.

It should be noted that most terminology disclosed in the present disclosure is defined in consideration of functions of the present disclosure, and can be differently determined according to intention of those skilled in the art or usual practices. Therefore, it is preferable that the above-mentioned terminology be understood on the basis of all contents disclosed in the present disclosure.

It will be apparent to those skilled in the art that various modifications and variations can be made in the present disclosure without departing from the spirit or scope of the disclosures. Thus, it is intended that the present disclosure covers the modifications and variations of this disclosure provided they come within the scope of the appended claims and their equivalents.

What is claimed is:

1. A method of processing a digital broadcast signal in a digital television (DTV) receiver, the method comprising:
receiving an event information table (EIT) containing information for a plurality of events in a predetermined time span;
receiving a time stamp table (TST) associated with one of the plurality of events, the time stamp table (TST) including time stamp type information defining a status of the event and a time stamp identification (ID) identifying the time stamp table (TST);
identifying the event associated with the time stamp table (TST) using the time stamp ID; and
determining the status of the identified event using the time stamp type information.

2. The method of claim 1, further comprising storing the identified event based on the determined status of the event.

3. The method of claim 1, further comprising excluding a commercial in the event, and storing the resultant event having no commercial.

4. The method of claim 1, wherein the time stamp type information notifies any one of a start and end of the event and a start and end of a commercial in the event.

5. The method of claim 1, wherein the time stamp type information pre-notifies any one of a start and end of the event and a start and end of a commercial in the event.

6. The method of claim 5, wherein a transmission period of the time stamp table(TST) which including the pre-notifying information becomes shorter as the start or end time is closer.

7. The method of claim 1, wherein the time stamp type information post-notifies any one of a start and end of the event and a start and end of a commercial in the event.

8. The method of claim 7, wherein a transmission period of the time stamp table(TST) which including the post-notifying information becomes longer as the start or end time becomes more distant.

9. The method of claim 1, wherein the time stamp type information and the time stamp identification (ID) which is included in the time stamp table (TST) may be included in a system time table (STT).

10. The method of claim 1, wherein the time stamp type information and the time stamp identification (ID) which is included in the time stamp table (TST) may be included in an audio/video (A/V) signal.

11. The method of claim 1, wherein the event information table (EIT) defines time stamp type information defining a status of the event and time stamp identification (ID) identifying the time stamp table (TST) in a descriptor associated with the event.

12. A digital television(DTV) receiver comprising:
a demultiplexer for demultiplexing an event information table (EIT) containing information for a plurality of events in a predetermined time span and a time stamp table (TST) associated with one of the plurality of events, which includes time stamp type information defining a status of the event and a time stamp identification (ID) identifying the time stamp table (TST);
a parser for parsing the demultiplexed information, and decoding the parsed information; and
a controller for identifying the event associated with the time stamp table (TST) using the time stamp ID and determining the status of the identified event using the time stamp type information.

13. The digital television receiver of claim 12, wherein the controller stores the identified event based on the determined status of the event.

14. The digital television receiver of claim 12, wherein the controller excludes a commercial in the event, and storing the resultant event having no commercial.

15. The digital television receiver of claim 12, wherein the time stamp type information notifies any one of a start and end of the event and a start and end of a commercial in the event.

16. The digital television receiver of claim 12, wherein the time stamp type information pre-notifies any one of a start and end of the event and a start and end of a commercial in the event.

17. The digital television receiver of claim 16, wherein a transmission period of the time stamp table(TST) which including the pre-notifying information becomes shorter as the start or end time is closer.

18. The digital television receiver of claim 12, wherein the time stamp type information post-notifies any one of a start and end of the event and a start and end of a commercial in the event.

19. The digital television receiver of claim 18, wherein a transmission period of the time stamp table(TST) which including the post-notifying information becomes longer as the start or end time becomes more distant.

20. The digital television receiver of claim 12, wherein the time stamp type information and the time stamp identification (ID) which is included in the time stamp table (TST) may be included in a system time table (STT).

21. The digital television receiver of claim 12, wherein the time stamp type information and the time stamp identification (ID) which is included in the time stamp table (TST) may be included in an audio/video (A/V) signal.

22. The digital television receiver of claim 12, wherein the event information table (EIT) defines time stamp type information defining a status of the event and time stamp identification (ID) identifying the time stamp table (TST) in a descriptor associated with the event.
